(19) United States
(12) Patent Application Publication
(10) Pub. No.: US 2004/0171295 A1
(43) Pub. Date: Sep. 2, 2004

(54) Wire retention device with insulation displacement contacts

(76) Inventors: Michael Canning, Plano, TX (US); Lyndon Ensz, Omaha, NE (US); Troy Long, Omaha, NE (US); Tim Miller, McKinney, TX (US); Ted Steele, Richardson, TX (US)

Correspondence Address: BIRCH STEWART KOLASCH & BIRCH, PO BOX 747, FALLS CHURCH, VA, 22040-0747, US

(21) Appl. No.: 10/786,037

(22) Filed: Feb. 26, 2004

Related U.S. Application Data
(60) Provisional application No. 60/449,869, filed on Feb. 27, 2003.

(51) Int. Cl. H01R 4/24

(52) U.S. Cl. 439/404

(57) ABSTRACT

A wiring interconnection device includes an insulation displacement connector (IDC) and a slot, formed in the device, leading to the IDC. The slot may include at least one retaining edge to hold a wire within the slot prior to encountering the IDC, e.g. a “parking” feature. Further, the slot may include at least one retaining edge to hold the wire in an electrical connection to the IDC, e.g. a “retaining” feature. In a preferred embodiment, the slot includes both the parking and retaining features.

### BACKGROUND OF THE INVENTION

1. Field of the Invention

The present invention relates to wiring interconnection devices. Particularly, the present invention relates to a device for terminating the twisted pairs of wires emanating from a cable. Such twisted pairs may be used in a telecommunication patching system for carrying signals, such as voice and/or data communications.

2. Discussion of the Related Art

FIG. 1 illustrates one type of a telecommunication cable E in accordance with the background art. The cable E of the background art includes four twisted pairs A, B, C and D, i.e. eight wires.

FIG. 2 illustrates an interconnection panel 1 in accordance with the background art. The interconnection panel 1 includes a first row 3 of insulation displacement connectors (IDCs) 7, and a second row 5 of IDCs 7. Each row 3 and 5 includes twenty-four IDCs 7.

FIG. 3 is a cross sectional view taken along line A-A in FIG. 2. As illustrated in FIG. 3, each IDC 7 includes a sharp, conductive blade 9, which cuts through an outer insulation layer of a wire to establish an electrical connection to the conductor within the wire. To establish the electrical connection, the wire is manually pressed into the IDC 7, either by hand or by a tool.

As illustrated in FIG. 4, eight of the IDCs 7 of the interconnection panel 1 of FIG. 2 can accommodate the four twisted pairs A, B, C and D of one cable E of FIG. 1. In other words, the interconnection panel has enough IDCs 7 for six cables E (twenty-four twisted pairs or forty-eight wires).

Although not illustrated in FIGS. 2-4, it should be noted that on the interconnection panel 1, the IDC's 7 are hardwired to jumper plugs, such as RJ-45 plugs. The jumper plugs permit interconnections between the twisted pairs A, B, C and D of the cables E and wires of other equipment. The jumper plugs allow these interconnections to be easily disconnected, reconfigured, and/or tested.

### SUMMARY OF THE INVENTION

Applicants have appreciated several drawbacks associated with the interconnection panels of the background art.

First, cutting edge technology requires ever increasing data transmission rate requirements for the cabling and interconnection systems. This requirement leads to tighter twist rates for the twisted pairs A, B, C and D within the cables E, smaller spacing between the contacts (IDC's 7) in the cable termination field (interconnection panel 1), and tougher insulation covering the wires forming the twisted pairs A, B, C and D.

These factors make the cable termination much harder to do and less reliable. For example, a combination of a tighter twist rate of wire pairs A, B, C and D and a tougher insulation covering the wires makes the wires and cables E extremely rigid. So that when such a wire is terminated onto an IDC 7, the wire has a tendency, over time, to loosen from IDC 7 and disconnect. This tendency is due to the natural resilience of the wire.

Wires often become disconnected when vibrated, touched or moved even slightly. This is especially problematic. Often a technician will manipulate or establish certain circuits on an interconnection panel 1, such as to establish a new connection or to reconfigure an existing connection. In working on the certain circuits, the technician's hand, tool or the wire the technician is working on will vibrate or touch other wires connected to the interconnection panel 1. Often these other wires will then disconnect from their respective IDCs 7, causing additional work for the technician.

It is an object of the present invention to address one or more of the drawbacks associated with the interconnection panels 1 of the background art.

In a first aspect of the present invention, a special wire retention feature is integrated into a wire slot leading into the IDC. When a wire is terminated onto the IDC, the retention feature will lock the wire in place and prevent the wire from separating from the IDC.

In a second aspect of the present invention, a “parking” feature is positioned in the wire slot above the opening to the IDC. The parking feature is designed to keep the wire in place prior to its termination into the IDC (e.g. prior to pressing the wire down into the IDC).

The parking feature enables a plurality of wires to be parked above the IDCs during installation. For example, all four wire pairs A, B, C and D of a cable E could be parked immediately above their associated IDCs 7. Then, a special tool having an engaging tong could be used to move the wires out of the park positions and into electrical connection with their associated IDCs 7.

A third aspect of the present invention is a combination of the first and second aspects. In the third aspect of the present invention, the wire slots leading into the IDCs 7 are provided with both the parking feature and the wire retention feature.

These and other features of the present invention are accomplished by a wiring interconnection device including an insulation displacement connector (IDC), wherein a slot is formed in the device and leads to the IDC. The slot may include at least one retaining edge to hold a wire within the slot prior to encountering the IDC, e.g. a “parking” feature. Further, the slot may include at least one retaining edge to hold the wire in an electrical connection to the IDC, e.g. a “retaining” feature. In a preferred embodiment, the slot includes both the parking and retaining features.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a cable including four twisted wire pairs, in accordance with the background art;

FIG. 2 is a perspective view of an interconnection panel, in accordance with the background art;

FIG. 3 is a cross sectional view taken along line A-A in FIG. 2;

FIG. 4 is a perspective view of the cable of FIG. 1 connected to the interconnection panel of FIG. 2;

FIG. 5 is a perspective view of an interconnection device, in accordance with the present invention;

FIG. 6 is a cross sectional view taken along line B-B of FIG. 5 and illustrating the first aspect of the present invention;

FIG. 7 is a cross sectional view taken along line B-B in FIG. 5 and illustrating a second aspect of the present invention; and

FIG. 8 is a cross sectional view taken along line B-B in FIG. 5 and illustrating a third aspect of the present invention.

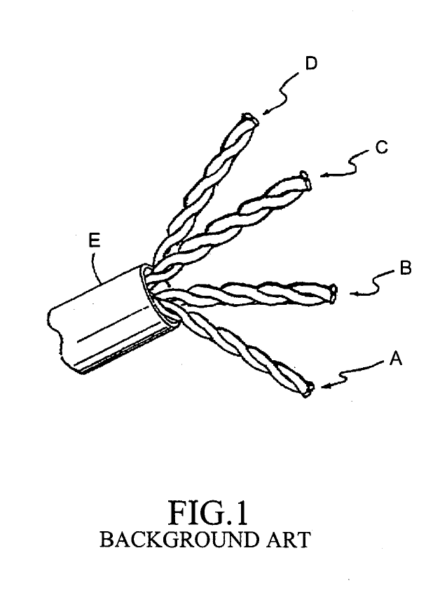

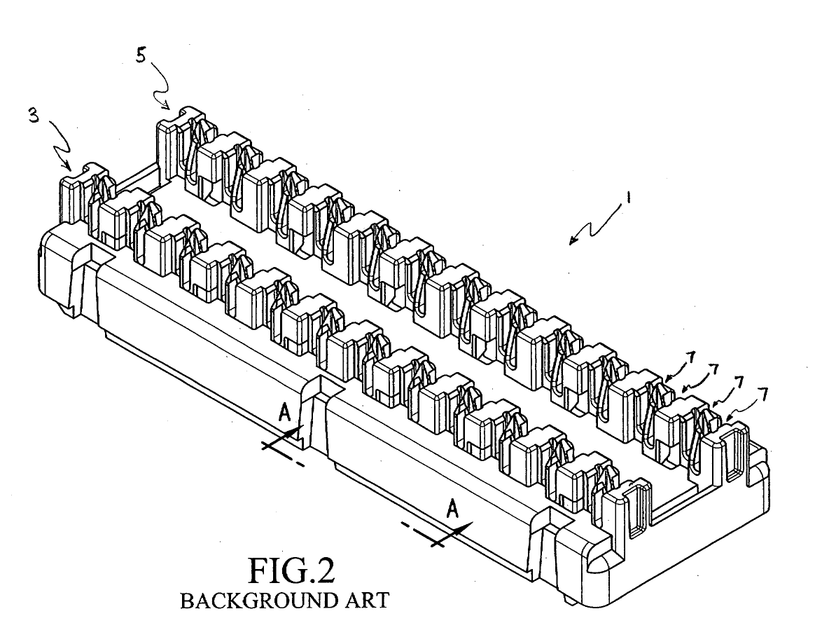

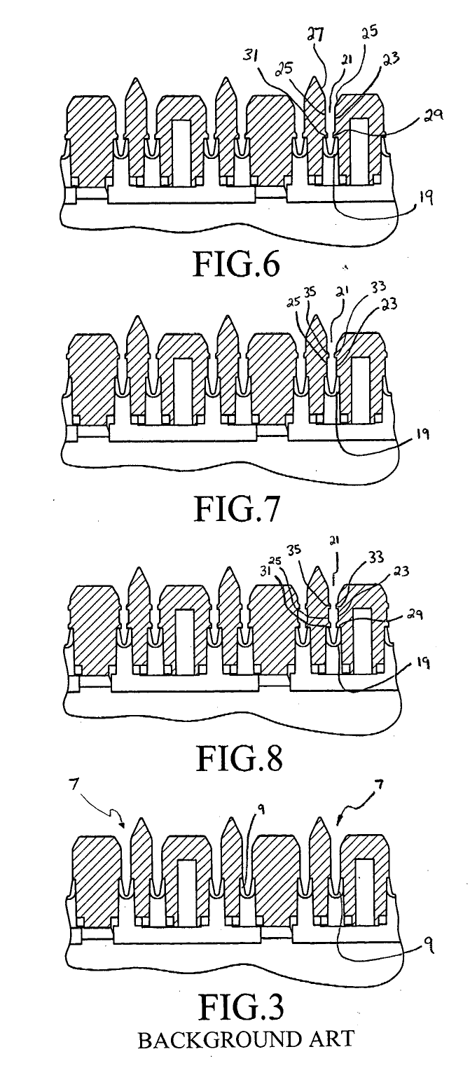

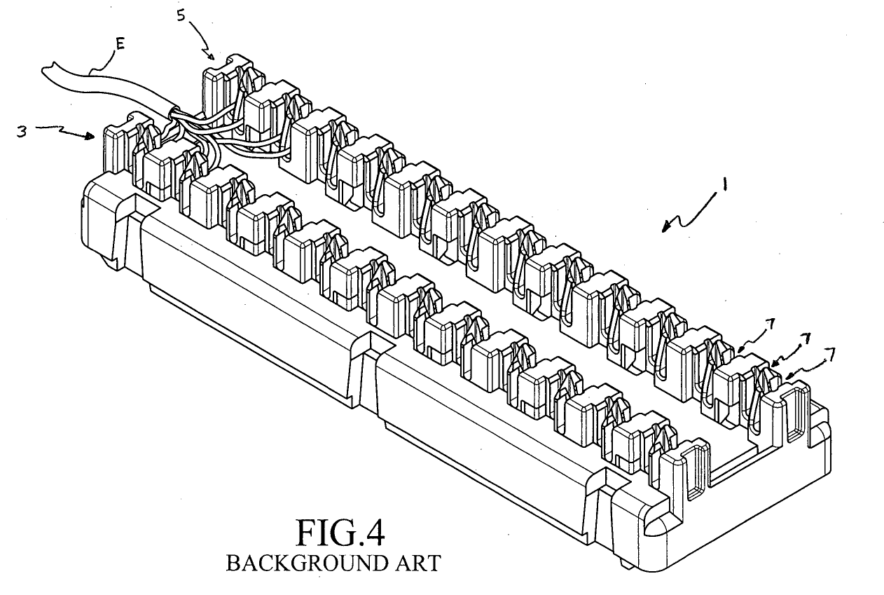

### DETAIL DESCRIPTION OF PREFERRED EMBODIMENTS

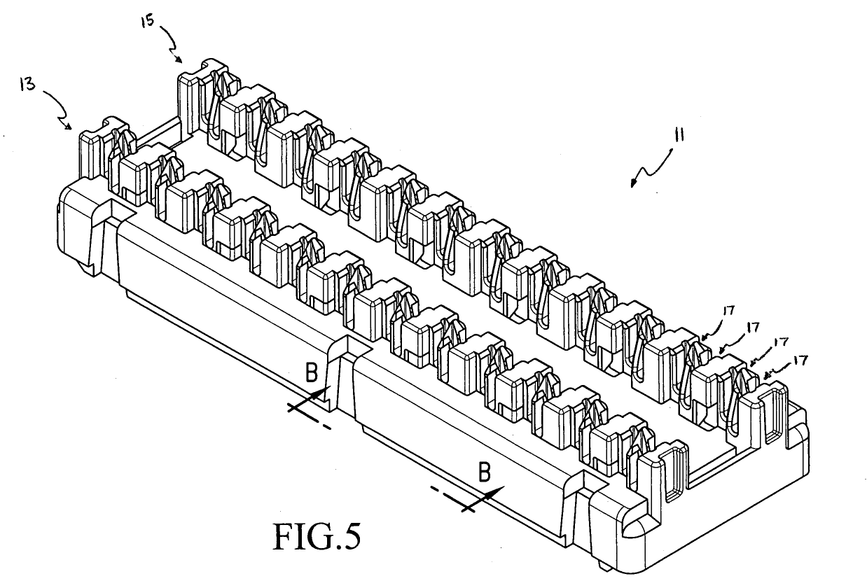

FIG. 5 is a perspective view of a wiring interconnection device, such as an interconnection panel 11, in accordance with the present invention. The interconnection panel 11 is approximately four inches in length and one inch in width, however this is only one example of the size, and the size may be varied depending upon desired design parameters. Like the background art, the interconnection panel 11 may include a first row 13 and a second row 15 of IDCs 17. However, the number of rows is may be varied, while keeping within the scope of the invention. The IDCs 17 of the present invention have distinctive structural features, which are revealed in FIGS. 6-8.

FIG. 6 is a cross sectional view taken along line B-B in FIG. 5. FIG. 6 illustrates a first aspect of the present invention. In FIG. 6, a slot 21 leads to a blade 19 of the IDC 17. The slot 21 is formed between a first wall 23 and a second wall 25, which may be formed of a plastic material. The first wall 23 includes a first angled portion 25 and the second wall includes a second angled portion 27. The first and second angled portions 25 and 27 come closer together in the direction of the blade 19 and assist the technician in starting a wire into the slot 21.

At the bottom of the slot 21, just prior to the blade 19 of the IDC 17, there is provided at least one retaining edge. FIG. 6 illustrates a first retaining edge 29 and a second retaining edge 31, provided on the first and second walls 23 and 25, respectively. Once a wire is engages the blade 19 of the IDC 17, the wire passes beyond first and second retaining edges 29, 31. The first and second retaining edges 29, 31 are like barbs or raised ramps. Of course, other shapes are within the purview of the present invention.

The first and second retaining edges 29, 31 are spaced from one another by a distance which is substantially the same as, and preferably slightly less than, the diameter of the wire to be electrically connected to the blade 19 of IDC 17. This spacing causes the wire to be retained in contact with the blade 19 of the IDC 17 regardless of vibrations or slight movements of the wire. For example, if an outer diameter of a wire to be electrically connected to the IDC 17 were 0.030 inches, the distance between the first and second retaining edges 29 and 31 might be set at approximately 0.027 inches.

Preferably, the first and second retaining edges 29, and 31 are sharp. A sharp edge has a tendency to slightly engage within the outer skin of the insulation of the wire. This frictional engagement further assists in keep the wire in an electrical connection with the blade 19 of the IDC 17.

FIG. 7 is a cross sectional view taken along line B-B in FIG. 5. FIG. 7 illustrates a second aspect of the invention, which may be an alternate and/or complementary feature to the first aspect of the invention illustrated in FIG. 6. FIG. 7 again illustrates that the slot 21 includes the first and second walls 23 and 25, which lead a wire to the blade 19 of the IDC 17. Once the wire has entered into the slot 21, there is a “parking” position along the length of the slot. The parking position resides after the entrance of the slot 21, but before the wire has contacted the blade 19 of the IDC 17.

The parking position resides just below a third retaining edge 33 provided on the first wall 23 and a fourth retaining edge 35 provided on the second wall 25. The third and fourth retaining edges 33 and 35 are spaced from one another by a distance which is substantially the same as, and preferably less than, the diameter of the wire to be electrically connected to the blade 19 of the IDC 17. This spacing causes the wire to be retained in an intermediate position within the slot 21 above the blade 19 of the IDC 17, i.e. the parking position. For example, if an outer diameter of a wire to be electrically connected to the blade 19 of the IDC 17 were 0.030 inches, the distance between the third and fourth retaining edges 33 and 35 would be set at approximately 0.027 inches.

During an installation process, a wire will remain in the slot 31 in the parking position regardless of vibrations or slight movements of the wire. Preferably, the third and fourth retaining edges 33 and 35 are sharp, as a sharp edge has a tendency to slightly engage within the outer skin of the insulation of the wire. This frictional engagement further assists in keeping the wire in the parked position above the blade 19 of the IDC 17.

Once several wires are parked. A tool can be used to individually push the parked wires into engagement with their associated blades 19 of the IDCs 17.

FIG. 8 is a cross sectional view taken along line B-B in FIG. 5. FIG. 8 illustrates the embodiments of FIGS. 6 and 7 in combination. The arrangement of FIG. 8 provides a comprehensive interconnection device which has the benefits of a parking feature in combination with the benefits of a retaining feature to keep a wire in electrical connection with a blade 19 of an IDC 17.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A wiring interconnection device comprising:
an insulation displacement connector (IDC); and
a slot formed in the device and leading to said IDC, wherein said slot includes at least one retaining edge to hold a wire in an electrical connection to said IDC.

2. The device according to claim 1, wherein said slot includes first and second retaining edges to hold a wire in an electrical connection to said IDC.

3. The device according to claim 2, wherein said first retaining edge is provided on a first wall forming said slot and said second retaining edge is provided on a second wall forming said slot.

4. The device according to claim 3, wherein said first and second walls, forming said slot, are angled and come closer together as they approach said IDC.

5. The device according to claim 3, wherein said first and second retaining edges are sharp.

6. The device according to claim 3, wherein said first and second retaining edges are spaced from one another by a distance which is less than or substantially equal to a diameter of a wire to be inserted into said IDC.

7. The device according to claim 3, wherein said first and second retaining edges are spaced from one another by a distance which is less than a diameter of a wire to be inserted into said IDC.

8. A wiring interconnection device comprising:
an insulation displacement connector (IDC); and
a slot formed in the device and leading to said IDC, wherein said slot includes at least one retaining edge to hold a wire within said slot prior to encountering said IDC.

9. The device according to claim 8, wherein said slot includes first and second retaining edges to hold a wire within said slot prior to encountering said IDC.

10. The device according to claim 9, wherein said first retaining edge is provided on a first wall forming said slot and said second retaining edge is provided on a second wall forming said slot.

11. The device according to claim 10, wherein said first and second walls, forming said slot, are angled and come closer together as they approach said IDC.

12. The device according to claim 10, wherein said first and second retaining edges are sharp.

13. The device according to claim 10, wherein said first and second retaining edges are spaced from one another by a distance which is less than or substantially equal to a diameter of a wire to be inserted into said IDC.

14. The device according to claim 10, wherein said first and second retaining edges are spaced from one another by a distance which is less than a diameter of a wire to be inserted into said IDC.

15. A wiring interconnection device comprising:
an insulation displacement connector (IDC); and
a slot formed in the device and leading to said IDC, wherein said slot includes at least one retaining edge to hold a wire within said slot prior to encountering said IDC, and at least one retaining edge to hold the wire in an electrical connection to said IDC after the wire encounters the IDC.

16. The device according to claim 15, wherein said slot includes first and second retaining edges to hold a wire within said slot prior to encountering said IDC, and third and fourth retaining edges to hold the wire in an electrical connection to said IDC.

17. The device according to claim 16, wherein said first and third retaining edges are provided on a first wall forming said slot and said second and fourth retaining edges are provided on a second wall forming said slot.

18. The device according to claim 17, wherein said first and second walls, forming said slot, are angled and come closer together as they approach said IDC.

19. The device according to claim 17, wherein said first, second, third and fourth retaining edges are sharp.

20. The device according to claim 17, wherein said first and second retaining edges are spaced from one another by a distance which is less than or substantially equal to a diameter of a wire to be inserted into said IDC, and said third and fourth retaining edges are spaced from one another by a distance which is less than or substantially equal to a diameter of a wire to be inserted into said IDC.

21. The device according to claim 17, wherein said first and second retaining edges are spaced from one another by a distance which is less than a diameter of a wire to be inserted into said IDC, and said third and fourth retaining edges are spaced from one another by a distance which is less than a diameter of a wire to be inserted into said IDC.
